(19) United States
(12) Patent Application Publication
(10) Pub. No.: US 2023/0002912 A1
(43) Pub. Date: Jan. 5, 2023

(54) WORKPIECE CLEANING APPARATUS AND CLEANING METHOD

(71) Applicant: Jiangsu XCMG Construction Machinery Research Institute Ltd., Jiangsu (CN)

(72) Inventors: Guangcun WANG, Jiangsu (CN); Xuemei ZONG, Jiangsu (CN); Bing HE, Jiangsu (CN)

(73) Assignee: Jiangsu XCMG Construction Machinery Research Institute Ltd., Jiangsu (CN)

(21) Appl. No.: 17/782,513

(22) PCT Filed: Jun. 24, 2020
(86) PCT No.: PCT/CN2020/098043

§ 371 Date: Jun. 3, 2022

(30) Foreign Application Priority Data
Jun. 18, 2020 (CN) 202010559647.3

(51) Int. Cl. C23G 1/28; B08B 3/08; B08B 3/12; B08B 3/14; C23G 1/02; C23G 1/24; C23G 1/36

(52) U.S. Cl. CPC C23G 1/28; B08B 3/08; B08B 3/12; B08B 3/14; C23G 1/02; C23G 1/24; C23G 1/36; B08B 2203/007

(57) ABSTRACT

The present disclosure relates to a workpiece cleaning device and a cleaning method. The workpiece cleaning device comprises: a frame (1); and a plurality of cleaning tanks disposed on the frame (1) side by side, comprising a molten salt cleaning tank (2) for cleaning a workpiece with molten salt, a first rinsing tank (5) for rinsing the workpiece cleaned with the molten salt, a de-rusting cleaning tank (6) for cleaning the workpiece rinsed in the first rinsing tank (5) with a de-rusting agent, a second rinsing tank (7) for rinsing the workpiece cleaned with the de-rusting agent, and an anti-rust cleaning tank (8) for cleaning the workpiece rinsed in the second rinsing tank (7) with anti-rust liquid, which are sequentially disposed from upstream to downstream in terms of procedure.

### CROSS-REFERENCE TO RELATED APPLICATIONS

This application is a National Stage Application of PCT/CN2020/098043, filed Jun. 24, 2020, which claims priority to Chinese Application No. 202010559647.3, filed Jun. 18, 2020, all of the contents of which are incorporated herein by reference in their entirety.

### FIELD OF THE DISCLOSURE

The present disclosure relates to a field of workpiece cleaning, and particularly, to a workpiece cleaning device and a cleaning method.

### BACKGROUND OF THE DISCLOSURE

Cleaning is a key link in processes of equipment manufacturing and remanufacturing, and is necessary means to ensure qualities of processes of inspection, repair and assembly. Incomplete cleaning will affect surface qualities of key parts, and even lead to an oil pollution of a whole machine, which seriously affects the reliability, safety and service life of a product.

The cleaning of heavy oil stains, paints, carbon deposits and rust on the surfaces of the parts is a technical problem in the industry: with a high viscosity, the heavy oil stain is composed of grease, sediment and wear debris, and accumulated in portions such as steps and pits which are difficult to be cleaned; the composition of the paint is complex, with a thickness of 0.05 to 0.15 mm and a high bonding strength with the matrix, so it is resistant to the conventional ultrasonic and jet cleaning; the carbon deposit is a complex colloidal carbon generated through a chemical reaction and an adhesion process when fuel oil is combusted, and it is an extremely hard mixture which is difficult to be dissolved by a solvent; and the rust is caused by a surface corrosion of a metal matrix, and a mechanical removal thereof can easily damage the surface qualities of the precision parts. In addition, in most cases, a pollution layer on a surface of a part appears in a form of mixture, which greatly increases the difficulty of cleaning. It is not easy to solve the problem just by a single cleaning method, while it is more difficult to clean pollution layers of inner holes and special-shaped surfaces. At present, the commonly used methods for removing the oil stains, paints, carbon deposits and rust usually adopt a plurality of combined procedures such as high-pressure water jet cleaning, steam cleaning, high-temperature roasting, sand blasting, shot blasting, chemical cleaning, manual grinding, etc. The procedures are complicated, and the production coordination is poor. In addition, the cleaning effect is poor and the cleaning efficiency is low for the multi-pollution layers, which can easily damage the matrix, and cause noise, dust and even chemical pollutions. It is clear that the traditional cleaning technology is far from meeting the requirement of cleaning the multi-pollution layers of the key parts.

### SUMMARY OF THE DISCLOSURE

According to an aspect of the embodiments of the present disclosure, there is provided a workpiece cleaning device, comprising:

a frame; and

a plurality of cleaning tanks, comprising a molten salt cleaning tank for cleaning a workpiece with molten salt, a first rinsing tank for rinsing the workpiece cleaned with the molten salt, a de-rusting cleaning tank for cleaning the rinsed workpiece with a de-rusting agent, a second rinsing tank for rinsing the workpiece cleaned with the de-rusting agent, and an anti-rust cleaning tank for cleaning the workpiece rinsed in the second rinsing tank with anti-rust liquid, which are sequentially disposed from upstream to downstream in terms of procedure.

In some embodiments, the molten salt cleaning tank, the first rinsing tank, the de-rusting cleaning tank, the second rinsing tank and the anti-rust cleaning tank are sequentially arranged along a first direction.

In some embodiments, the workpiece cleaning device further comprises a plurality of heating members disposed in one-to-one correspondence with at least a part of the plurality of cleaning tanks, the heating members being configured to heat the corresponding cleaning tanks.

In some embodiments, the workpiece cleaning device further comprises a plurality of vibration members disposed in one-to-one correspondence with at least a part of the plurality of cleaning tanks, the vibration members being configured to trigger vibrations of cleaning liquid in the corresponding cleaning tanks.

In some embodiments, the vibration member is disposed outside the cleaning tank; or the vibration member is disposed inside the cleaning tank.

In some embodiments, the vibration member is disposed outside the cleaning tank, and a heat insulation board is disposed between the vibration member and the cleaning tank.

In some embodiments, the workpiece cleaning device further comprises a bearing member connected to the frame and extended into the cleaning tank, to bear a workpiece to be cleaned in the cleaning tank.

In some embodiments, side walls of the molten salt cleaning tank are provided with reinforcing ribs in a form of frame structures, to prevent the side walls of the molten salt cleaning tank from being deformed after being heated.

In some embodiments, the workpiece cleaning device further comprises a plurality of cleaning liquid circulation loops disposed in one-to-one correspondence with at least a part of the plurality of cleaning tanks, the cleaning liquid circulation loop comprising:

a circulation pipe comprising an inlet communicated with the cleaning tank and an outlet communicated with the cleaning tank;

a filter disposed in the circulation pipe to filter cleaning liquid flowing therethrough; and

an acid and alkali resistant circulation pump communicated with the circulation pipe and the filter to enable a circular filtration of the cleaning liquid in the corresponding cleaning tank.

In some embodiments, the first rinsing tank, the de-rusting cleaning tank, the second rinsing tank and the anti-rust cleaning tank are each provided with the cleaning liquid circulation loop correspondingly.

In some embodiments, the workpiece cleaning device further comprises a waste water treatment portion communicated with at least a part of the plurality of cleaning tanks.

In some embodiments, the first rinsing tank, the de-rusting cleaning tank, the second rinsing tank and the anti-rust cleaning tank are each communicated with the waste water treatment portion.

In some embodiments, the workpiece cleaning device further comprises a waste gas treatment portion communicated with at least a part of the plurality of cleaning tanks.

In some embodiments, the molten salt cleaning tank, the first rinsing tank, the de-rusting cleaning tank, the second rinsing tank and the anti-rust cleaning tank are each communicated with the waste gas treatment portion.

According to another aspect of the present disclosure, there is provided a cleaning method of the above workpiece cleaning device, comprising:

placing a workpiece to be cleaned into the molten salt cleaning tank, heating the molten salt cleaning tank to a first predetermined temperature, and cleaning the workpiece with molten salt by vibration;

after the workpiece cleaned by molten salt is cooled to a second predetermined temperature, placing the workpiece into the first rinsing tank (5), and removing residual molten salt on a surface of the workpiece with cleaning liquid by vibration;

placing the workpiece rinsed in the first rinsing tank into the de-rusting cleaning tank, and de-rusting the workpiece with a de-rusting agent by vibration;

placing the workpiece cleaned in the de-rusting cleaning tank into the second rinsing tank, and removing residual de-rusting agent on the surface of the workpiece with cleaning liquid by vibration;

placing the workpiece rinsed in the second rinsing tank into an anti-rust cleaning tank, cleaning the surface of the workpiece by vibration, and forming a protective film on the surface of the workpiece with an anti-rust agent.

In some embodiments, the first predetermined temperature is not higher than 350° C.; the second predetermined temperature is 150° C.; the de-rusting agent is one of a weak acid de-rusting agent and a neutral de-rusting agent; the cleaning liquid in the second rinsing tank (7) is one of deionized water and purified water; the anti-rust agent comprises an aqueous anti-rust agent.

By applying the technical solution of the present disclosure, the organic pollution layer on the surface of the workpiece can be removed in the molten salt cleaning tank, the rust on the surface of the workpiece can be removed in the de-rusting cleaning tank, and an anti-rust layer can be formed on the surface of the workpiece after the cleaning in the anti-rust cleaning tank. The workpiece cleaning device can improve the cleaning effect of the workpiece.

Other features and advantages of the present disclosure will become apparent from the following detailed descriptions of the exemplary embodiments of the present disclosure made with reference to the drawings.

### BRIEF DESCRIPTION OF THE ACCOMPANYING DRAWINGS

The drawings constituting a part of the present disclosure are used to provide a further understanding of the present disclosure, and the illustrative embodiments and the descriptions thereof in the present disclosure are used to explain the present disclosure, rather than improper limitations thereto. In the drawings:

FIG. 1 illustrates a schematic structural diagram of a workpiece cleaning device according to an embodiment of the present disclosure;

FIG. 2 illustrates a partial enlarged view of a workpiece cleaning device according to an embodiment of the present disclosure;

FIG. 3 illustrates a schematic structural side view of a workpiece cleaning device according to an embodiment of the present disclosure;

FIG. 4 illustrates a schematic structural diagram of a waste water treatment system, a waste gas treatment system and a cleaning liquid circulation system of a cleaning device of a workpiece cleaning device according to an embodiment of the present disclosure;

FIG. 5 illustrates a process flowchart of a workpiece cleaning device according to an embodiment of the present disclosure;

FIG. 6 illustrates a view of a workpiece to be cleaned; and

FIG. 7 illustrates a view of a workpiece cleaned by a workpiece cleaning device according to an embodiment of the present disclosure.

### REFERENCE NUMERALS

1: frame; 2: molten salt cleaning tank; 3: tank cover; 4: exhaust port; 5: first rinsing tank; 6: de-rusting cleaning tank; 7: second rinsing tank; 8: anti-rust cleaning tank; 9: five vibration member; 10: fourth heating member; 11: fourth vibration member; 12: third heating member; 13: third vibration member; 14: second heating member; 15: second vibration member; 16: tank wall; 17: bearing member; 18: first vibration member; 19: first heating member; 20: threaded connector; 21: first adhesive layer; 22: heat insulation board; 23: second adhesive layer; 24: reinforcing rib; 25: waste water treatment portion; 26: main pipe; 27: valve; 28: drainage pump; 29: filter; 30: circulation pipe; 31: circulation pump; 32: waste gas collection pipe; 33: waste gas treatment portion.

### DETAILED DESCRIPTION OF THE PREFERRED EMBODIMENTS

In order that the objectives, technical solutions and advantages of the present disclosure are clearer, the present disclosure will be further described in detail with reference to the embodiments and drawings. Here, the illustrative embodiments of the present disclosure and the descriptions thereof are used to explain the present disclosure, rather than limitations thereto.

FIG. 1 illustrates a schematic structural diagram of a workpiece cleaning device according to an embodiment of the present disclosure. As illustrated in FIG. 1, the workpiece cleaning device of this embodiment comprises: a frame 1, and a plurality of cleaning tanks disposed side by side on the frame 1, comprising a molten salt cleaning tank 2 for cleaning a workpiece with molten salt, a first rinsing tank 5 for rinsing the workpiece cleaned with the molten salt, a de-rusting cleaning tank 6 for cleaning the workpiece rinsed in the first rinsing tank 5 with a de-rusting agent, a second rinsing tank 7 for rinsing the workpiece de-rusting cleaned with the de-rusting agent, and an anti-rust cleaning tank 8 for cleaning the workpiece rinsed in the second rinsing tank 7 with anti-rust liquid.

The molten salt cleaning tank 2, the first rinsing tank 5, the de-rusting cleaning tank 6, the second rinsing tank 7 and the anti-rust cleaning tank 8 are sequentially disposed from upstream to downstream in terms of procedure.

The molten salt cleaning tank 2, the first rinsing tank 5, the de-rusting cleaning tank 6, the second rinsing tank 7 and the anti-rust cleaning tank 8 are sequentially arranged along a first direction.

The workpiece cleaning device further comprises a plurality of heating members disposed in one-to-one correspondence with at least a part of the plurality of cleaning tanks, the heating members being configured to heat the corresponding cleaning tanks.

The heating member comprises a first heating member 19 configured to heat the molten salt cleaning tank 2. The heating member comprises a second heating member 14 configured to heat the de-rusting cleaning tank 6. The heating member comprises a third heating member 12 configured to heat the second rinsing tank 7. The heating member comprises a fourth heating member 10 configured to heat the anti-rust cleaning tank 8.

The workpiece cleaning device further comprises a plurality of vibration members disposed in one-to-one correspondence with at least a part of the plurality of cleaning tanks, the vibration members being configured to trigger vibrations of cleaning liquid in the corresponding cleaning tanks.

In some embodiments, the vibration member comprises an ultrasonic vibrator.

The vibration member comprises a first vibration member 18 configured to trigger a vibration of the molten salt cleaning tank 2. The vibration member comprises a second vibration member 15 configured to trigger a vibration of the first rinsing tank 5. The vibration member comprises a third vibration member 13 configured to trigger a vibration of the de-rusting cleaning tank 6. The vibration member comprises a fourth vibration member 11 configured to trigger a vibration of the second rinsing tank 7. The vibration member comprises a fifth vibration member 9 configured to trigger a vibration of the anti-rust cleaning tank 8.

In some embodiments, the vibration member is mounted outside the cleaning tank, and in other embodiments, the vibration member is mounted inside the cleaning tank.

In this embodiment, the first vibrating member 18 is mounted outside the molten salt cleaning tank 2; the second vibration member 15 is mounted outside the first rinsing tank 5; the third vibration member 13 is mounted inside the de-rusting cleaning tank 6; the fourth vibration member 11 is mounted inside the second rinsing tank 7; and the fifth vibration member 9 is mounted outside the anti-rust cleaning tank 8.

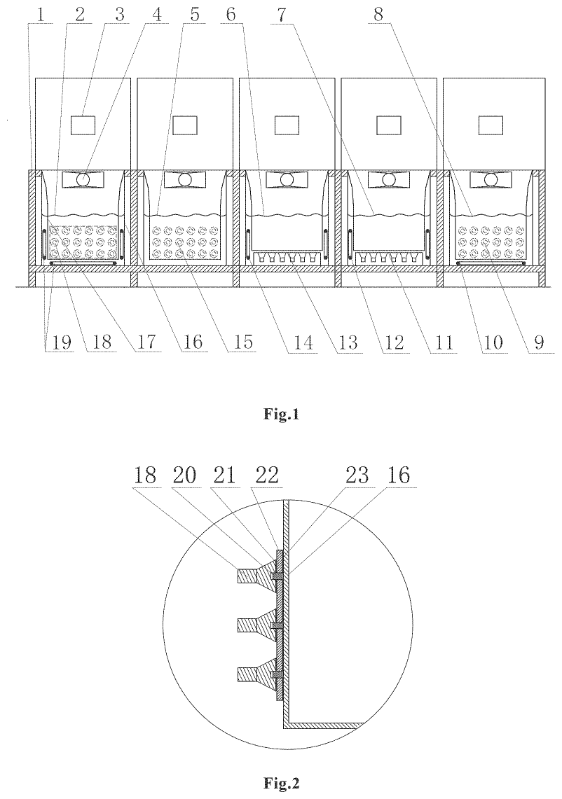

FIG. 2 illustrates a partial enlarged view of a workpiece cleaning device according to an embodiment of the present disclosure. As illustrated in FIG. 2, a heat insulation board 22 is disposed between the first vibration member 18 and a tank wall 16 of the molten salt cleaning tank 2.

The first vibration member 18, the heat insulation board 22 and the tank wall 16 are connected together by a threaded connector 20.

In some embodiments, the first vibration member 18 and the heat insulation board 22 are bonded to each other by adhesive, and a first adhesive layer 21 is formed between the first vibration member 18 and the heat insulation board 22. The insulation board 22 and the tank wall 16 are bonded to each other by adhesive, and a second adhesive layer 23 is formed between the insulation board 22 and the tank wall 16.

In some embodiments, the adhesive is an inorganic high temperature resistant glue.

As illustrated in FIG. 1, the workpiece cleaning device further comprises a bearing member 17 connected to the frame 1 and extended into the cleaning tank, to bear a workpiece to be cleaned in the cleaning tank. Optionally, each of the cleaning tanks is provided with a bearing member 17.

In some embodiments, the bearing member 17 is detachably connected to the frame 1.

The cleaned workpiece is placed in the bearing member 17, which is beneficial to preventing the workpiece from colliding and damaging the heating member or the vibration member in the cleaning tank, and also beneficial to preventing a deformation of the cleaning tank due to a heavy weight of the workpiece, thus playing a role in protecting the cleaning tank.

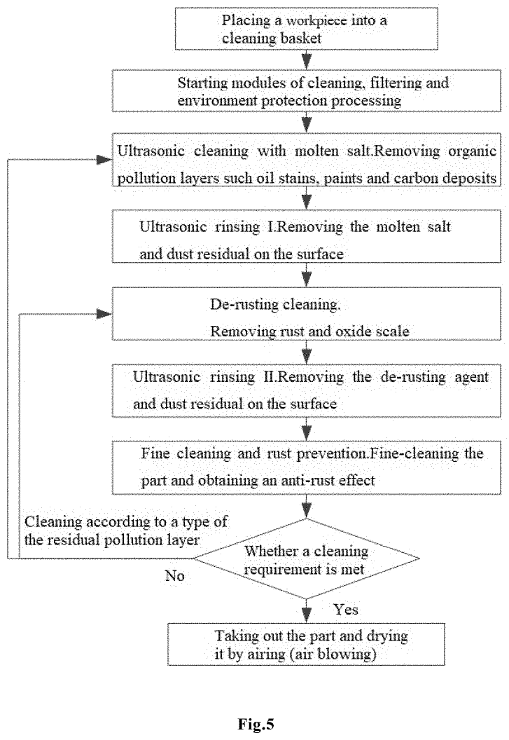

As illustrated in FIG. 4, the workpiece cleaning device further comprises a plurality of cleaning liquid circulation loops, which are disposed in one-to-one correspondence with at least a part of the plurality of cleaning tanks and comprise a circulation pipe 30 and a filter 29.

The circulation pipe 30 comprises an inlet communicated with the cleaning tank and an outlet communicated with the cleaning tank; the filter 29 is disposed in the circulation pipe 30 to filter the cleaning liquid flowing therethrough.

The first rinsing tank 5, the de-rusting cleaning tank 6, the second rinsing tank 7 and the anti-rust cleaning tank 8 are each provided with a cleaning liquid circulation loop.

The circulation pipe 30 is further provided with a circulation pump 31, under the action of which, the cleaning liquid in the cleaning tank is filtered by the filter 29 and then returned to the cleaning tank. Each of the cleaning liquid circulation loop circulates the cleaning liquid in the corresponding cleaning tank for cleaning, which is beneficial to prolonging the service life of the cleaning liquid and saving the cleaning cost.

In some embodiments, the filter 29 is an acid and alkali resistant filter.

The filter 29 comprises a replaceable filter element. When the workpiece in the cleaning tank cannot meet a predetermined requirement after being cleaned, the filter element of the corresponding filter 29 can be easily replaced to ensure the cleaning quality of the workpiece in the cleaning tank.

As illustrated in FIG. 4, the workpiece cleaning device further comprises a waste water treatment portion 25 communicated with at least a part of the plurality of cleaning tanks.

The first rinsing tank 5, the de-rusting cleaning tank 6, the second rinsing tank 7 and the anti-rust cleaning tank 8 are each communicated with the waste water treatment portion 25.

The workpiece cleaning device further comprises a main pipe 26 communicated with the waste water treatment portion 25, and a plurality of branch pipes disposed in one-to-one correspondence with the plurality of cleaning tanks and respectively communicated with the corresponding cleaning tanks and the main pipe 26. The main pipe 26 is provided with a drainage pump 28 for conveying waste liquid in the plurality of cleaning tanks to the waste water treatment portion 25 through the branch pipes.

Each of the branch pipes is provided with a valve 27. By controlling the valve 27 to be opened and closed and the drainage pump 28 to be turned on and off, the waste water in the plurality of cleaning tanks is discharged to the waste water treatment portion 25 for environmental protection treatment, thus realizing a zero discharge of the waste water after the cleaning. Optionally, the valve 27 is an electrically operated valve.

As illustrated in FIG. 4, the workpiece cleaning device further comprises a waste gas treatment portion 33 communicated with at least a part of the plurality of cleaning tanks.

The molten salt cleaning tank 2, the first rinsing tank 5, the de-rusting cleaning tank 6, the second rinsing tank 7 and the anti-rust cleaning tank 8 are each communicated with the waste gas treatment portion 33.

As illustrated in FIGS. 1, 3 and 4, the workpiece cleaning device further comprises a tank cover 3 connected to an upper end of the corresponding cleaning tank through a hinge member. The cleaning tank is further provided with an exhaust port 4 communicated with the waste gas treatment portion 33. The exhaust port 4 is located at an upper portion of the cleaning tank and below the tank cover 3, and the tank cover 3 can prevent gas generated in the workpiece cleaning process the from overflowing.

The workpiece processing device further comprises a waste gas collection pipe 32 which is communicated with the exhaust ports 4 of the plurality of cleaning tanks and with the waste gas treatment portion 33, to convey the waste gas generated in the plurality of cleaning tanks to the waste gas treatment portion 33.

The waste gas and water steam generated in the plurality of cleaning tanks are conveyed to the waste gas treatment portion 33 for environmental protection treatment, which is beneficial to improving the on-site environment and reducing the pollution to the external environment.

In this embodiment, the molten salt cleaning tank 2 is mounted at a first station of the frame 1, and a tank body of the molten salt cleaning tank 2 is made of corrosion resistant stainless steel (e.g., 316L, etc.); a bottom and side walls of the tank body are provided with the first heating members 19 to melt the molten salt and control a cleaning temperature; front and rear sides outside the tank are mounted with the first vibration members 18, and a hard high temperature resistant insulation board 22 is disposed between the first vibration member 18 and the molten salt cleaning tank 2.

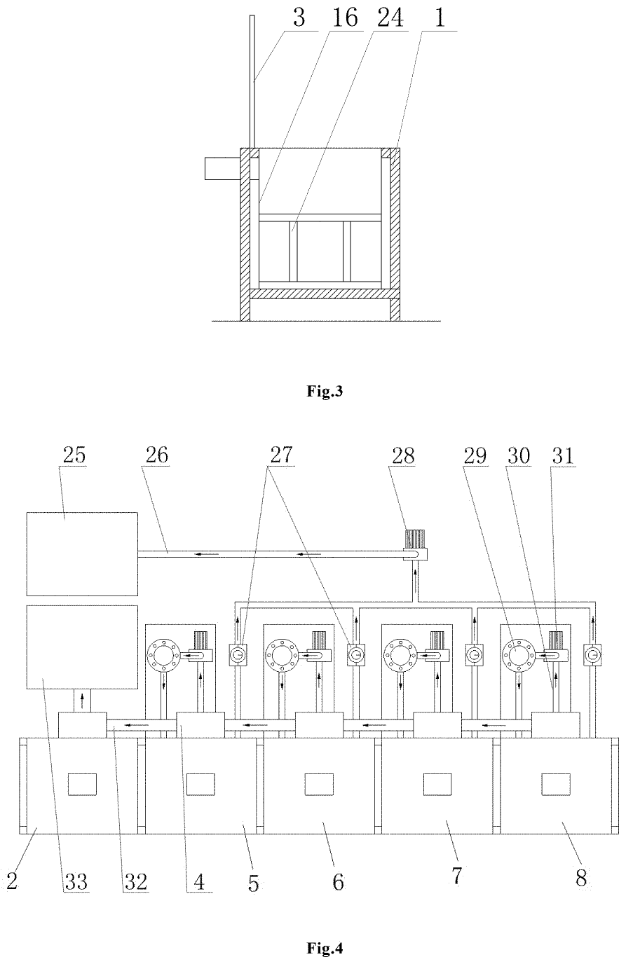

As illustrated in FIG. 3, the side walls of the molten salt cleaning tank 2 are provided with reinforcing ribs 24 to prevent the side wall of the molten salt cleaning tank 2 from being deformed inward or outward after being heated. The reinforcing rib 24 is a frame structure.

The first rinsing tank 5 is mounted at a second station of the frame 1, and a tank body of the first rinsing tank 5 is made of corrosion resistant stainless steel (e.g., 316L, etc.). An outer bottom surface of the cleaning tank is mounted with a second vibration member 15 connected to the tank body of the first rinsing tank 5 and the second vibration member 15 by bolts and high-strength glue.

The de-rusting cleaning tank 6 is mounted at a third station of the frame 1, and a tank body of the de-rusting cleaning tank 6 is made of polymer material (e.g., PP), which can effectively prevent a de-rusting agent from corroding the tank body. A bottom of the de-rusting cleaning tank 6 is mounted with a third vibration member 13 to realize de-rusting cleaning by vibration and greatly improve the de-rusting efficiency. The third vibrating member 13 is a throw-in vibrator box. The second heating elements 14 are mounted at the bottom of the de-rusting cleaning tank 6 and both sides of the third vibrating element 13 to realize a temperature control during the de-rusting cleaning.

The second rinsing tank 7 is mounted at a fourth station of the frame 1, and a tank body of the second rinsing tank 7 is made of polymer material (e.g., PP), which can effectively prevent a de-rusting agent from corroding the tank body. A bottom of the second rinsing tank 7 is mounted with a fourth vibration member 11 to realize cleaning by vibration. The fourth vibrating member 11 is a throw-in vibrator box. The third heating members 12 are mounted at the bottom of the second rinsing tank 7 and both sides of the fourth vibration member 11 to realize a temperature control during the cleaning.

The anti-rust cleaning tank 8 is mounted at a fourth station of the frame 1, and a tank body of the anti-rust cleaning tank 8 is made of corrosion-resistant stainless steel (e.g., 316L, etc.). An outer bottom surface of the anti-rust cleaning tank 8 is mounted with a fifth vibration member 9 connected to the tank body of the anti-rust cleaning tank 8 by bolts and high-strength glue.

According to another aspect of the present disclosure, the present disclosure further provides a cleaning method using the workpiece cleaning device of this embodiment, and the cleaning comprises:

placing a workpiece to be cleaned into the molten salt cleaning tank 2, heating the molten salt cleaning tank 2 to a first predetermined temperature, and cleaning the workpiece with molten salt by vibration;

placing the workpiece, which is cleaned with the molten salt to a second predetermined temperature, into the first rinsing tank 5, and removing residual molten salt on a surface of the workpiece with cleaning liquid by vibration;

placing the workpiece rinsed in the first rinsing tank 5 into the de-rusting cleaning tank 6, and de-rusting the workpiece with a de-rusting agent by vibration;

placing the workpiece cleaned in the de-rusting cleaning tank 6 into the second rinsing tank 7, and removing residual de-rusting agent on the surface of the workpiece with cleaning liquid by vibration;

placing the workpiece rinsed in the second rinsing tank 7 into an anti-rust cleaning tank 8, cleaning the surface of the workpiece by vibration, and forming a protective film on the surface of the workpiece with an anti-rust agent,

wherein the first predetermined temperature is not higher than 350° C.; the second predetermined temperature is 150° C.; the de-rusting agent is one of a weak acid de-rusting agent and a neutral de-rusting agent; the cleaning liquid in the second rinsing tank 7 is one of deionized water and purified water; and the anti-rust agent comprises an aqueous anti-rust agent.

FIG. 5 illustrates a process flowchart of a cleaning method according to an embodiment of the present disclosure. As illustrated in FIG. 5, the cleaning method comprises:

Step a: placing a workpiece to be cleaned into a cleaning basket, putting the cleaning basket and the workpiece into a molten salt cleaning tank 2 together, and decomposing and peeling off organic pollution layers such as grease, oil stain, paint, adhesive and carbon deposit on a surface of the workpiece with molten salt at a first predetermined temperature.

Step b: slowly placing the workpiece cleaned with the molten salt and cooled to a proper temperature, into a first rinsing tank 5, and removing residual molten salt and dust on the surface by a gas explosion and an ultrasonic cavitation impact of high-temperature parts, while the cleaning efficiency can be improved by adjusting the vibration power and the cleaning temperature. On the workpiece after the above treatment, the organic pollution layer can be completely removed and the rust and the oxide scale can be exposed.

Step c: placing the workpiece into a de-rusting cleaning tank 6, and realizing rapid reaction and peeling of the rust and the oxide scale under the comprehensive action of the ultrasonic cavitation impact and the de-rusting agent, while the de-rusting efficiency can be improved by properly adjusting the ultrasonic power and the cleaning temperature, and the de-rusted workpiece will exhibit a metallic color.

Step d: placing the workpiece after the de-rusting cleaning into a second rinsing tank 7, removing the residual de-rusting agent and dust on the surface by an ultrasonic action, and the cleaning efficiency can be improved by properly adjusting the ultrasonic power and the cleaning temperature. On the workpiece after the above treatment, the multi-pollution layer has been completely removed, and the metallic color is exposed. At this time, the workpiece has a high surface activity, and can be easily oxidized and discolored.

Step e: placing the workpiece exhibiting the metallic color into an anti-rust cleaning tank 8 as soon as possible. On the one hand, a surface cleanliness of the workpiece meets the assembly requirement by ultrasonic cleaning, and on the other hand, a very thin protective film is formed on the surface of the workpiece under the action of the anti-rust liquid, so that the workpiece can obtain an anti-rust effect, while the cleaning efficiency can be improved by properly adjusting the ultrasonic power and the cleaning temperature. The cleaned workpiece may be dried naturally or by a dry airflow.

In step a, the organic pollution layer is cleaned by adopting a special alkaline molten salt combination formula, and the first predetermined temperature for cleaning the workpiece should not be higher than 350° C.

In step b, before entering the first rinsing tank 5, the workpiece should be cooled to about 150° C. to prevent liquid droplets from splashing due to the high temperature of the workpiece.

In step c, a weak acid or neutral de-rusting agent should be used for the de-rusting cleaning and the cleaning time should be strictly controlled, to prevent acid mist or an excessive corrosion during the cleaning and avoid a hydrogen embrittlement of the workpiece.

In step d, clean water with low content of chlorine and oxygen, such as deionized water or purified water, should be used in the ultrasonic rinsing II tank, to prevent the surface of the workpiece from being corroded and oxidized after the cleaning.

In step e, an aqueous anti-rust agent should be used for fine cleaning and rust prevention, which will not contaminate the surface of the part and then keeps a perfect appearance of the workpiece, leaves no trace, and does not affect the accuracy. The anti-rust effect with different durations can be obtained by adjusting a dilution ratio of the anti-rust agent.

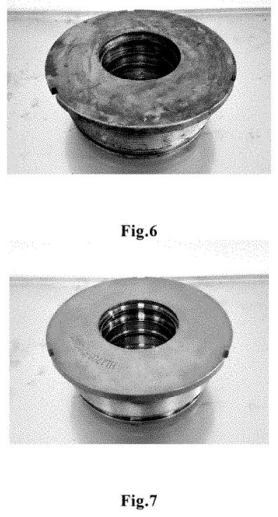

The following content illustrates an example of cleaning a guide sleeve of an articulated oil cylinder of a shield machine using the workpiece cleaning device of this embodiment (FIG. 6 illustrates a workpiece before the cleaning, surfaces and grooves of which have paints/oil stains and rust, and FIG. 7 illustrates the workpiece after the cleaning):

Before cleaning, there are oil stains and aged paint layers on the surfaces of the guide sleeve, while oil stains, rust and other pollution layers on the inner wall, grooves and threaded surfaces.

Firstly, an ultrasonic compound cleaning is carried out on the molten salt. After the molten salt is cleaned under a temperature of 300° C. for about 10 min, no gas comes out from the molten salt cleaning tank 2, which proves that the paints and oil stains have been completely removed. The workpiece is cooled to 150° C. and rinsed in the first rinsing tank 5 for 1 min. Then, ultrasonic de-rusting is carried out in the de-rusting cleaning tank 6 with a weak acid de-rusting agent composed of organic acid for 3 min. Next, the workpiece is rinsed in the second rinsing tank 7 with deionized water for 1 min. The workpiece is anti-rust cleaned in the anti-rust cleaning tank 8 for 1 min, and then dried in the air.

After the above cleaning, a good effect is achieved on the surfaces, grooves and threaded surfaces. A cleanliness test shows that a pollutant mass is 13.8 mg, which is far less than a cleanliness requirement (90 mg) of a hydraulic cylinder and then meets the assembly requirement. An anti-corrosion test shows that the anti-rust effect of the guide sleeve is 21 days at a dilution ratio of 1:30.

To sum up, the cleaning device of this embodiment can realize integrated, efficient and environmentally-friendly cleaning of various pollution layers such as heavy oil stains, paints, carbon deposits and rust on the surfaces of the parts. The workpiece cleaning device of this embodiment has the following technical effects:

(1) The cleaning ability: it integrates the super decontamination capability of the molten salt cleaning, the ultrasonic cavitation impact and the vibration stirring; under the actions of special molten salt formula and de-rusting formula, it can quickly remove the organic and inorganic pollution layers such as heavy oil stains, paints, carbon deposits and rust on the surfaces, grooves, inner holes of the complex parts without damaging the matrixes of the parts.

(2) The cleaning efficiency: the advantages of submerged ultrasonic cleaning are brought into full play, and the cleaning procedures are integrated into one device, so that the cleaning procedures are centralized and well-coordinated, which is convenient to realize the automatic cleaning of the multi-pollution layers.

(3) The environmental protection requirement: the cleaning system has a cleaning agent circulation filtration device to improve the service life of the cleaning agent; and a centralized recovery and treatment device for the waste water and the waste gas, so that the cleaning process can be environment-friendly and pollution-free.

Those described above are just exemplary embodiments of the present disclosure, rather than limitations thereto. Any modification, equivalent substitution, improvement, etc. made within the spirit and principle of the present disclosure should fall within the protection scope of the present disclosure.

1. A workpiece cleaning device, comprising:
a frame; and
a plurality of cleaning tanks, disposed side by side on the frame, the plurality of cleaning tanks comprise a molten salt cleaning tank configured to clean a workpiece with molten salt, a first rinsing tank configured to rinse the workpiece cleaned with the molten salt, a de-rusting cleaning tank configured to clean the rinsed workpiece with a de-rusting agent, a second rinsing tank configured to rinse the workpiece cleaned with the de-rusting agent, and an anti-rust cleaning tank configured to clean the workpiece rinsed in the second rinsing tank with anti-rust liquid, which are sequentially disposed from upstream to downstream in terms of procedure.

2. The workpiece cleaning device according to claim 1, wherein the molten salt cleaning tank, the first rinsing tank, the de-rusting cleaning tank, the second rinsing tank and the anti-rust cleaning tank are sequentially arranged.

3. The workpiece cleaning device according to claim 1, further comprising a plurality of heating members disposed in one-to-one correspondence with at least some of the plurality of cleaning tanks, the heating members being configured to heat the corresponding cleaning tanks.

4. The workpiece cleaning device according to claim 1, further comprising a plurality of vibration members disposed in one-to-one correspondence with at least some of the plurality of cleaning tanks, the vibration members being configured to trigger vibrations of cleaning liquid in the corresponding cleaning tanks.

5. The workpiece cleaning device according to claim 4, wherein,
the vibration member is disposed outside the cleaning tank; or
the vibration member is disposed inside the cleaning tank.

6. The workpiece cleaning device according to claim 5, wherein the vibration member is disposed outside the cleaning tank, and a heat insulation board is disposed between the vibration member and the cleaning tank.

7. The workpiece cleaning device according to claim 1, further comprising a bearing member connected to the frame and extended into the cleaning tank, so as to bear a workpiece to be cleaned in the cleaning tank and protect the heating member in the cleaning tank.

8. The workpiece cleaning device according to claim 1, wherein reinforcing ribs in a form of frame structures, are provided on side walls of the molten salt cleaning tank, to prevent the side walls of the molten salt cleaning tank from being deformed after being heated.

9. The workpiece cleaning device according to claim 1, further comprising a plurality of cleaning liquid circulation loops disposed in one-to-one correspondence with at least some of the plurality of cleaning tanks, the cleaning liquid circulation loop comprising:
a circulation pipe, comprising an inlet communicated with the cleaning tank and an outlet communicated with the cleaning tank;
a filter, disposed in the circulation pipe to filter cleaning liquid flowing therethrough; and
an acid and alkali resistant circulation pump, communicated with the circulation pipe and the filter to enable a circular filtration of the cleaning liquid in the corresponding cleaning tank.

10. The workpiece cleaning device according to claim 9, wherein the first rinsing tank, the de-rusting cleaning tank, the second rinsing tank and the anti-rust cleaning tank are each provided with the cleaning liquid circulation loop correspondingly.

11. The workpiece cleaning device according to claim 1, further comprising a waste water treatment portion communicated with at least some of the plurality of cleaning tanks.

12. The workpiece cleaning device according to claim 11, wherein the first rinsing tank, the de-rusting cleaning tank, the second rinsing tank and the anti-rust cleaning tank are each communicated with the waste water treatment portion.

13. The workpiece cleaning device according to claim 1, further comprising a waste gas treatment portion communicated with at least some of the plurality of cleaning tanks.

14. The workpiece cleaning device according to claim 13, wherein the molten salt cleaning tank, the first rinsing tank, the de-rusting cleaning tank, the second rinsing tank and the anti-rust cleaning tank are each communicated with the waste gas treatment portion.

15. A cleaning method of the workpiece cleaning device according to claim 1, comprising:
placing a workpiece to be cleaned into the molten salt cleaning tank, heating the molten salt cleaning tank to a first predetermined temperature, and cleaning the workpiece with molten salt by vibration;
after the workpiece cleaned by molten salt is cooled to a second predetermined temperature, placing the workpiece into the first rinsing tank, and removing residual molten salt on a surface of the workpiece with cleaning liquid by vibration;
placing the workpiece rinsed in the first rinsing tank into the de-rusting cleaning tank, and de-rusting the workpiece with a de-rusting agent by vibration;
placing the workpiece cleaned in the de-rusting cleaning tank into the second rinsing tank, and removing residual de-rusting agent on the surface of the workpiece with cleaning liquid by vibration; and
placing the workpiece rinsed in the second rinsing tank into an anti-rust cleaning tank, cleaning the surface of the workpiece by vibration, and forming a protective film on the surface of the workpiece with an anti-rust agent.

16. The cleaning method according to claim 15, wherein,
the first predetermined temperature is not higher than 350° C.;
the second predetermined temperature is about 150° C.;
the de-rusting agent is one of a weak acid de-rusting agent and a neutral de-rusting agent;
the cleaning liquid in the second rinsing tank is one of deionized water and purified water; and
the anti-rust agent comprises an aqueous anti-rust agent.
